(19) United States
(12) Patent Application Publication
(10) Pub. No.: US 2024/0311680 A1
(43) Pub. Date: Sep. 19, 2024

(54) MACHINE-LEARNING-BASED BUDGET UTILIZATION PREDICTOR

(71) Applicant: SAP SE, Walldorf (DE)

(72) Inventor: Pierre Emmanuel POUMELLEC, Roquefort-les-Pins (FR)

(21) Appl. No.: 18/122,482

(22) Filed: Mar. 16, 2023

(51) Int. Cl. G06N 20/00

(52) U.S. Cl. CPC G06N 20/00

(57) ABSTRACT

A computer-implemented, machine-learning-based budget utilization predictor is disclosed herein. An embodiment of the predictor operates by receiving first funds management data associated with an entity, the first funds management data corresponding to a current accounting period; generating input data for a machine learning (ML) model from the first funds management data, the ML model being trained to predict whether a budget surplus or budget deficit will exist for the entity at the end of the current accounting period based on training data generated from second funds management data associated with the entity, the second funds management data corresponding to one or more previous accounting periods; providing the input data as input to the ML model; and obtaining as an output from the ML model a prediction of whether the budget surplus or budget deficit will exist for the entity at the end of the current accounting period.

### BACKGROUND

Funds management (FM) systems exist that enable users thereof to record purchase orders (FM commitments) and invoices (FM actuals) against a budget, such as an approved budget for a public organization for a current accounting period (e.g., a current fiscal year). A conventional FM system can also compare an approved budget for the current accounting period, which can be thought of as a consumable amount, against all purchase orders and invoices recorded to date against that budget, which can be thought of as a consumed amount, to determine a currently available budget. However, when the consumed amount exceeds the consumable amount, the currently available budget will be a negative number and a budget deficit situation arises. A budget deficit situation can be extremely problematic for a variety of reasons. For example, in a budget deficit situation, the FM system may block the submission of any new purchase orders associated with the budget, which can bring important projects to a standstill. Furthermore, rectifying the budget deficit situation may require extensive auditing involving a large amount of data or may even require an entity to hold an emergency vote to approve supplemental budget.

Another situation that can be problematic may occur when the end of the current accounting period arrives and the budget has not been fully consumed, resulting in a budget surplus. In a budget surplus situation, it may be necessary to engage in a carry-forward process to transfer the surplus to the following accounting period and this process may be complex and time consuming. Furthermore, having a budget surplus at the end of the current accounting period may be deemed undesirable since it may lead to a reduction of budget for a subsequent accounting period.

### BRIEF DESCRIPTION OF THE DRAWINGS

The accompanying drawings are incorporated herein and form a part of the specification.

FIG. 1 is a block diagram of a system for implementing a machine-learning-based budget utilization predictor, according to some embodiments.

FIG. 2 is a flowchart of a first method for implementing a machine-learning-based budget utilization predictor, according to some embodiments.

FIG. 3 is a flowchart of a second method for implementing a machine-learning-based budget utilization predictor, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, a conventional funds management (FM) system may present to a user thereof a currently available budget for a relevant entity (e.g., a public or private organization). For example, such a system may determine a currently available budget for a current accounting period (e.g., a current fiscal year) by deducting from a budget approved for the accounting period (the consumable amount) all of the purchase order (FM commitment) amounts and invoice (FM actual) amounts that have been applied to date to that budget (the consumed amount). When the consumed amount exceeds the consumable amount, the currently available budget will be a negative number and a budget deficit situation arises. A budget deficit situation can be extremely problematic for a variety of reasons. For example, in a budget deficit situation, the FM system may block the submission of any new purchase orders associated with the budget, which can bring important projects to a standstill. Furthermore, rectifying the budget deficit situation may require extensive auditing involving a large amount of data or may even require an entity to hold an emergency vote to approve supplemental budget.

Another situation that can be problematic may occur when the end of the current accounting period arrives and the budget has not been fully consumed, resulting in a budget surplus. In a budget surplus situation, it may be necessary to engage in a carry-forward process to transfer the surplus to the following accounting period and this process may be complex and time consuming. Furthermore, having a budget surplus at the end of the current accounting period may be deemed undesirable since it may lead to a reduction of budget for a subsequent accounting period.

Provided herein are system, method and/or computer program product embodiments, and/or combinations and sub-combinations thereof, for implementing a machine-learning-based budget utilization predictor that addresses at least some of the foregoing shortcomings of conventional FM systems. In embodiments, the machine-learning-based budget utilization predictor can be used to predict whether a particular fund, funds center, funded program, or combination thereof, will experience a budget deficit or a budget surplus by the end of a current accounting period (e.g., a current fiscal year). In the case where a budget deficit is predicted, a user or organization can take preventative steps to ensure that supplemental budget is obtained before the budget deficit actually occurs, thereby avoiding a situation where purchase orders are blocked and ensuring that projects stay on track. Preventing the budget deficit before it happens can also help to avoid having to perform complex audits and/or an emergency vote to obtain supplemental funding.

Furthermore, since embodiments can be used to predict that a given fund, funds center, funded program, or combination thereof, will have a budget surplus at the end of a current accounting period, such embodiments enable a user or organization to take preventative steps to spend the entirety of the relevant budget before the end of the current accounting period. This can help to avoid having to engage in a potentially complex and time-consuming carry-forward process to transfer the budget surplus to the following accounting period and also can help to avoid a budget reduction for a subsequent accounting period.

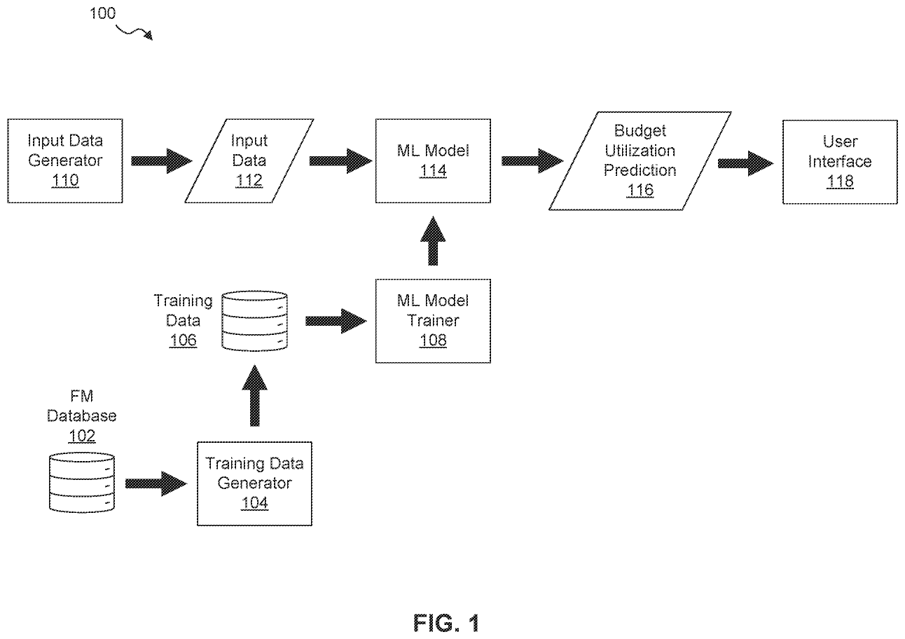

FIG. 1 is a block diagram of a system 100 for implementing a machine-learning-based budget utilization predictor in accordance with an embodiment. As shown in FIG. 1, system 100 includes a funds management (FM) database 102, a training data generator 104, training data 106, a machine learning (ML) model trainer 108, an input data generator 110, input data 112, an ML model 114, a budget utilization prediction 116, and a user interface (UI) 118. Each of these elements will now be described.

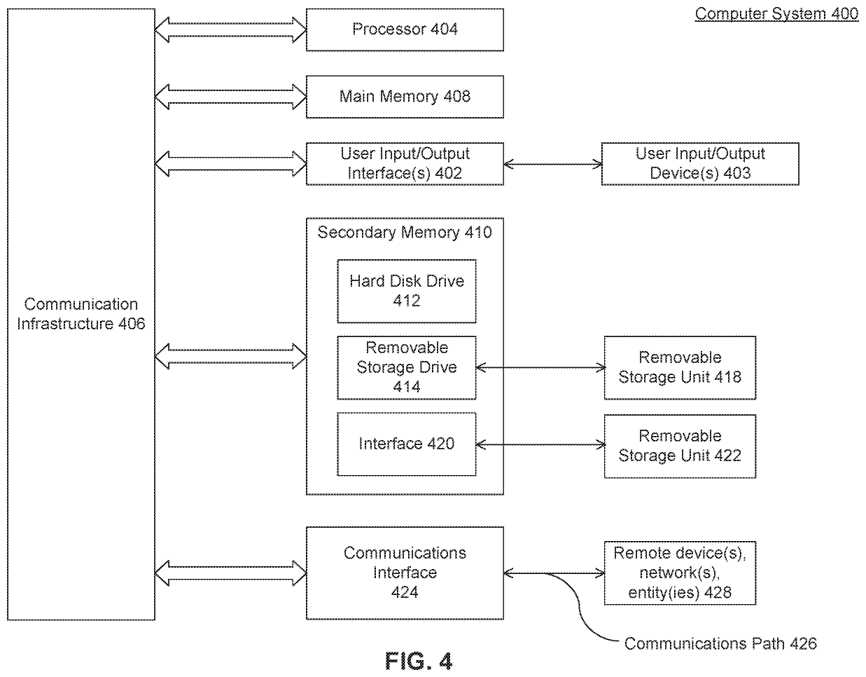

FM database 102 is intended to represent a database that stores FM data for an entity, wherein such entity may comprise, for example and without limitation, a public organization, a private organization, or an individual person. FM database 102 may be stored, for example, in a volatile memory (e.g., random access memory (RAM)), a non-volatile storage device (e.g., a disk), or in a distributed and/or redundant manner across multiple memories and/or storage devices. In an embodiment, FM database 102 is managed by and accessed via a corresponding database management system (DBMS), which is not shown in FIG. 1 for the sake of simplicity. FM database 102 and the corresponding DBMS may be implemented on one or more computer systems, such as computer system 400 as described below in reference to FIG. 4. FM database 102 and the corresponding DBMS may also be implemented on one or more servers of an enterprise network and/or a cloud computing network and accessed via a client computer system that is connected thereto, although these examples are not intended to be limiting.

Training data generator 104 may be implemented by processing logic that can comprise hardware (e.g., circuitry, dedicated logic, programmable logic, microcode, etc.), software (e.g., instructions executing on a processing device), or a combination thereof. In an embodiment, training data generator 104 is implemented in one or more software processes executing on one or more processor-based computer systems, such as computer system 400 as described below in reference to FIG. 4. Training data generator 104 is configured to obtain FM data associated with a particular entity from FM database 102 for one or more previous accounting periods (e.g., one or more previous fiscal years), and to generate training data 106 therefrom. Training data generator 104 may be configured to automatically interact with FM database 102 to extract the FM data therefrom. Alternatively, a different entity (e.g., a person and/or a computer-implemented process) may operate to obtain the FM data from FM database 102 and store it in one or more memories or storage device(s) that are accessible to training data generator 104.

In an embodiment, training data generator 104 may be configured to generate training data 106, in part, by cleaning the FM data received from FM database 102. For example, training data generator 104 may be configured to remove variables from the FM data that include values that are not applicable to training. Additionally or alternatively, training data generator 104 may be configured to remove redundant variables from the FM data. Still other methods for cleaning the FM data may be used.

In an embodiment, FM database 102 comprises part of an FM system (e.g., an FM system for Public Sector Management) that represents objects to which costs or quantities are posted as account assignment objects. Furthermore, in such embodiment, the FM system represents each account assignment object to which FM budget data and commitment/actual data is updated as an availability control object (also referred to herein as a “budget address”) in support of an availability control feature of the FM system that enables users to track budget consumption. Each availability control object may be defined by a plurality of account assignment variables. The values of the account assignment variables for a given availability control object may be specified by a user, for example, at the time the availability control object is created.

In accordance with such an embodiment, the FM data obtained by training data generator 104 from FM database 102 may include FM data corresponding to a number of availability control objects (or budget addresses). In further accordance with such an embodiment, training data generator 104 may be configured to generate training data 106 by processing the FM data obtained from FM database 102 to generate a dataset that includes values for three numeric variables for each unique combination of values corresponding to a set of account assignment variables that define an availability control object (or budget address) within the FM system, wherein the three numeric variables include a consumable amount (e.g., an approved budget), a consumed amount (e.g., total of actuals and commitments), and an available amount that is the difference between the consumable amount and the consumed amount. The resulting dataset may be filtered by financial management area (or other organizational unit within an accounting structure for an organization), accounting period (e.g., fiscal year) and/or by ledger (e.g., by payment and commitment ledger) to generate suitable training data 106.

In an embodiment, the aforementioned set of account assignment variables that define an availability control object include or consist of the following variables: fund, budget period, funds center, commitment item, functional area, grant, and funded program. Each of these account assignment variables will now be described.

Fund refers to an account assignment variable to which a value (e.g., a categorical value) may be assigned that represents a financial resource that is provided for a specific purpose by a sponsor and managed separately.

Budget period is an account assignment variable that can be used to differentiate budget execution of one fund during the period of available budget authority (one year, multiple years, unlimited). Budget period can be defined in terms of one or more years, but it can also be a quarter, a year that last 16 months, etc. Budget period can be assigned to any number of funds to create a fund combination dependent on the budget period. Budget period is not to be confused with the aforementioned accounting period (e.g., fiscal year).

Funds center refers to an account assignment variable to which a value (e.g., a categorical value) may be assigned that specifies an organizational unit within a financial management area that represents the structure of an organization (areas of responsibility, departments, and projects) in the form of a hierarchy. Budget can be assigned to funds centers in the FM system. Budget is used up as postings are made to funds centers with commitment and actual values. Funds centers in the FM system may be arranged in hierarchies.

Commitment item refers to an account assignment variable to which a value (e.g., a categorical value) may be assigned that represents a functional grouping of expenditures and revenues within a financial management area. Commitment items classify budget transactions and business transactions affecting liquidity into revenue, expenditure, and cash balance items.

Functional area refers to an account assignment variable to which a value (e.g., a categorical value) may be assigned that sorts operating expenses according to their function. Examples of functional area include but are by no means limited to manufacturing, administration, sales and distribution, and research and development.

Grant refers to an account assignment variable to which a value (e.g., a categorical value) may be assigned that specifies an external sponsor of funding.

Funded program refers to an account assignment variable to which a value (e.g., a categorical value) may be assigned that identifies a program within FM with an operational purpose and defined time frame. Funded programs can range from simple activities to complex projects and can cross an organization's fiscal years, funding sources, and organizational units. Examples may include things like: facility modernization; financial system replacement; park beautification; and street and highway safety. Funded programs enable a user to record budget, control postings, and monitor the performance of internal projects.

In further accordance with the foregoing embodiment, in order to generate training data 106, training data generator 104 may be configured to convert each numeric value associated with the available amount variable into a Boolean value. This conversion can ensure that training data 106 is suitable for training a ML classifier that renders a yes/no prediction for budget deficit or budget surplus. For example, in a scenario in which the ML classifier renders a yes/no prediction for budget deficit, if a numeric value associated with the available amount variable is greater than or equal to zero, then training data generator 104 may convert the numeric value into a “No”, “False” or “0” value, whereas if the numeric value associated with the available amount variable is less than zero, then training data generator 104 may convert the numeric value into a “Yes”, “True” or “1” value, respectively. As another example, in a scenario in which the ML classifier renders a yes/no prediction for budget surplus, if a numeric value associated with the available amount variable is greater than zero, then training data generator 104 may convert the numeric value into a “Yes”, “True” or “1” value, whereas if the numeric value associated with the available amount variable is less than or equal to zero, the training data generator 104 may convert the numeric value into a “No”, “False” or “0” value, respectively. However, these are only examples and other pairs of Boolean values may be used to represent the available amount variable.

Although the foregoing refers to an embodiment in which training data 106 is generated from consumable, consumed, and amount available data for different availability control objects, it should be understood that this is an example only. In different embodiments, alternative or alternative information may be used to generate training data 106. For example, in a further embodiment, additional datasets and/or variables (e.g., attributes of purchase orders) may be used to generate training data 106 if such information is observed to improve the budget utilization prediction.

In an embodiment, training data generator 104 is configured to perform principal component analysis (PCA) to determine a set of variables to be included in training data 106. Training data generator 104 may be configured to perform PCA automatically and/or in response to user input. For example, training data generator 104 may be configured to perform PCA to determine the set of account assignment variables that will be used to determine each availability control object for which a consumable amount, consumed amount and available amount will be determined and from which training data 106 will be generated.

Training data 106 generated by training data generator 104 may be stored in a volatile memory (e.g., RAM), a non-volatile storage device (e.g., a disk), or in a distributed and/or redundant manner across multiple memories and/or storage devices. In an embodiment, training data 106 is stored in one or more memories or storage devices that are accessible by ML model trainer 108.

ML model trainer 108 may be implemented by processing logic that can comprise hardware (e.g., circuitry, dedicated logic, programmable logic, microcode, etc.), software (e.g., instructions executing on a processing device), or a combination thereof. In an embodiment, ML model trainer 108 is implemented in one or more software processes executing on one or more processor-based computer systems, such as computer system 400 as described below in reference to FIG. 4. ML model trainer 108 is configured to use training data 106 to train an ML model to predict whether a budget deficit or a budget surplus will exist (e.g., for the entity associated with training data 106) at an end of a current accounting period. The trained ML model is represented as ML model 114 in FIG. 1.

In an embodiment, ML model 114 comprises a supervised ML classifier. In further accordance with such an embodiment, ML model 114 may comprise a generalized linear model supervised ML classifier. However, these examples are not intended to be limiting and ML model 114 may comprise a variety of other ML model or ML classifier types.

In an embodiment, ML model trainer 108 may be configured to perform testing and validation of ML model 114 automatically and/or in response to user input. For example, ML model trainer 108 may be configured to train ML model 114 on training data representing one prior accounting period (e.g., fiscal year) and one ledger (e.g., payment ledger or commitment ledger) and then test and validate ML model 114 using training data for a different prior accounting period and the same ledger. However, this is only one example and a variety of other techniques may be used by ML model trainer 108 to test and validate ML model 114.

Once ML model 114 has been trained by ML model trainer 108, ML model 114 can then be used to perform budget utilization prediction. ML model trainer 108 may be implemented by processing logic that can comprise hardware (e.g., circuitry, dedicated logic, programmable logic, microcode, etc.), software (e.g., instructions executing on a processing device), or a combination thereof. In an embodiment, ML model 114 is executed as one or more software processes on one or more processor-based computer systems, such as computer system 400 as described below in reference to FIG. 4, to perform budget utilization prediction. In one embodiment, ML model 114 is accessible to a user as part of a suite of budget monitoring tools within the aforementioned FM system. For example, the FM system may comprise a UI, such as a graphical UI (GUI), via which a user can execute ML model 114 to perform budget utilization prediction.

In an embodiment, the budget utilization prediction can be performed for the same entity whose prior accounting period FM data was used to generate training data 106. However, in an alternate embodiment, the budget utilization prediction can be performed for a different entity than the entity whose prior accounting period FM data was used to generate training data 106.

Input data generator 110 may be implemented by processing logic that can comprise hardware (e.g., circuitry, dedicated logic, programmable logic, microcode, etc.), software (e.g., instructions executing on a processing device), or a combination thereof. In an embodiment, input data generator 110 is implemented in one or more software processes executing on a processor-based computer system, such as computer system 400 as described below in reference to FIG. 4. Input data generator 110 is configured to generate input data 112 that is provided to ML model 114 to perform the aforementioned budget utilization prediction function. In an embodiment, input data generator 110 is configured to receive FM data associated with an entity (e.g., the entity whose prior accounting period FM data was used to generate training data 106) and corresponding to a current accounting period (e.g., a current fiscal year) and generate input data 112 therefrom.

In an example embodiment, the FM data received by input data generator 110 comprises user input (e.g., received via a GUI or other UI of the FM system) that specifies one or more funds, funds centers, and/or funded programs for a current accounting period for which a budget deficit or budget surplus prediction is sought. In further accordance with such an embodiment, input data generator 110 may be configured to pass information about the relevant fund(s), funds center(s) and/or funded program(s) to ML model 114 as part of input data 112 so that ML model 114 can generate a budget utilization prediction for each fund, funds center and/or funded program. Such information may include, for example, the values associated with a set of account assignment variables of an availability control object (or budget address) for each specified fund, funds center, and/or funded program. In further accordance with this example, the set of account assignment variables may include or consist of the following: fund, budget period, funds center, commitment item, functional area, grant, and funded program.

In a further example embodiment, the FM data received by input data generator 110 comprises user input that specifies a financial management area (or other organizational unit within an accounting structure of an organization) and input data generator 110 may pass information about any fund(s), funds center(s) and/or funded program(s) that are included within the specified financial management area to ML model 114 as part of input data 112 so that ML model 114 can generate a budget utilization prediction for each such fund, funds center and/or funded program. In a still further example, the user may further specify a ledger (e.g., payment or commitment) for which the prediction function should be performed.

ML model 114 is configured to process input data 112 to produce a budget utilization prediction 116. Depending upon the implementation, budget utilization prediction 116 may comprise a budget deficit prediction and/or a budget surplus prediction. For example, in an embodiment, for each fund, funds center and/or funded program for which input data 112 is provided, ML model 114 produces a corresponding yes/no prediction for budget deficit or budget surplus. For example, ML model 114 may be configured to analyze the values associated with certain account assignment variables for a fund, funds center, and/or funded program availability control object (budget address) to predict whether such fund, funds center and/or funded program will experience a budget deficit or budget surplus in a current accounting period, and to output a corresponding budget deficit or budget surplus prediction accordingly.

UI 118 may be implemented by processing logic that can comprise hardware (e.g., circuitry, dedicated logic, programmable logic, microcode, etc.), software (e.g., instructions executing on a processing device), or a combination thereof. In an embodiment, UI 118 is implemented in one or more software processes executing on a processor-based computer system, such as computer system 400 as described below in reference to FIG. 4. UI 118 is configured to present budget utilization prediction 116 to a user. UI 118 may be any type of UI that may be used to present budget utilization prediction 116 to a user, including but not limited to a GUI, a command line interface (CLI), a menu-driven UI, a touch UI, a voice UI (VUI), a form-based UI, or a natural language UI. In an embodiment, UI 118 may comprise a UI of the aforementioned FM system.

In an embodiment, ML model 114 also outputs a probability associated with each budget deficit or budget surplus prediction. Such probability may represent a degree of confidence associated with the corresponding budget deficit or budget surplus prediction. For example, in an embodiment, for each availability control object (budget address) for which a prediction is sought, ML model 114 may produce output arranged in the following manner:

Budget address|Budget Deficit(Yes/No)|Probability[0,1].

Alternatively, the output may be arranged in the following manner.

Budget address|Budget Surplus(Yes/No)|Probability[0,1].

Such output may be presented to a user, for example, via UI 118.

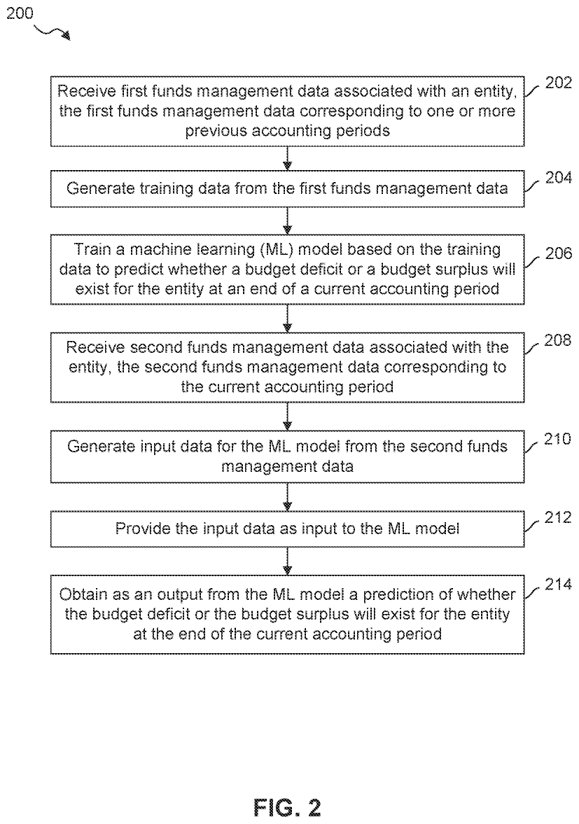

FIG. 2 is a flowchart of a method 200 for implementing a machine-learning-based budget utilization predictor, according to an embodiment. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to that example embodiment.

In 202, training data generator 104 receives first FM data associated with an entity, the first FM data corresponding to one or more previous accounting periods. In an embodiment, training data generator 104 receives the first FM data from a database (e.g., FM database 102) of an FM system.

In 204, training data generator 104 generates training data 106 from the first FM data. In an embodiment in which training data generator 104 receives the FM data from an FM system, training data generator 104 may generate training data 106 from the first FM data by extracting from the first FM data a consumable amount, a consumed amount and an available amount for each unique combination of values corresponding to a plurality of account assignment variables that define an availability control object within the FM system. By way of example only and without limitation, the plurality of account assignment variables may consist of or include: a fund variable, a budget period variable, a funds center variable, a commitment item variable, a functional area variable, a grant variable, and a funded program variable. In further accordance with such an embodiment, training data generator 104 may also generate training data 106 from the first FM data by filtering the first FM data by one or more of a financial management area, a prior accounting period, or a ledger type. In still further accordance with such an embodiment, training data generator 104 may generate training data 106 from the first FM data by, for each unique combination of values corresponding to the plurality of account assignment variables, converting the available amount to a Boolean value.

In 206, ML model trainer 108 trains ML model 114 based on training data 106 to predict whether a budget deficit or a budget surplus will exist for the entity at an end of a current accounting period. In an embodiment, training ML model 114 comprises training a supervised ML classifier. In further accordance with such an embodiment, training the supervised ML classifier comprises training a generalized linear model supervised classifier.

In 208, input data generator 110 receives second FM data associated with the entity, the second FM data corresponding to the current accounting period. In an embodiment, the second FM data specifies a fund, funds center, funded program, or a combination thereof, for a current accounting period for which a budget deficit or budget surplus prediction is sought.

In 210, input data generator 110 generates input data 112 for ML model 114 from the second FM data. In an embodiment, input data generator 110 generates input data 112 for ML model 114 from the second FM data by providing values associated with a set of account assignment variables of an availability control object (or budget address) for each fund, funds center, funded program, or combination thereof specified by the second FM data and for which a budget deficit or budget surplus predication is sought. In further accordance with this example, the set of account assignment variables may include or consist of the following: fund, budget period, funds center, commitment item, functional area, grant, and funded program.

In 212, input data generator 110 provides input data 112 as input to ML model 114, which processes the input data 112 to produce the prediction of whether the budget deficit or the budget surplus will exist for the entity at the end of the current accounting period.

In 214, UI 118 obtains prediction 116 as an output from ML model 114, wherein prediction 116 indicates whether the budget deficit or the budget surplus will exist for the entity at the end of the current accounting period. UI 118 may present prediction 116 to a user. In an embodiment, 214 further includes UI 118 obtaining as an output from ML model 114 a probability associated with prediction 116, which UI 118 may also present to the user.

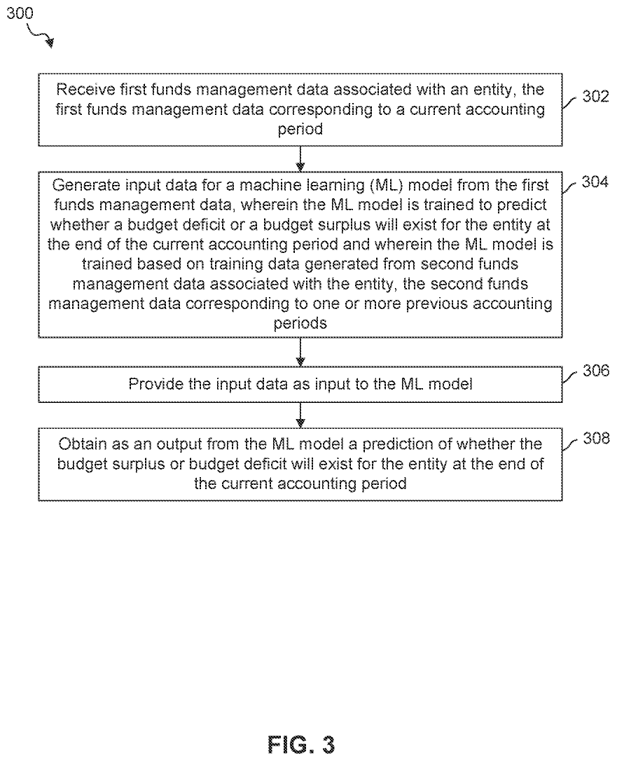

FIG. 3 is a flowchart for a method 300 for implementing a machine-learning-based budget utilization predictor, according to an embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In 302, input data generator 110 receives first FM data associated with an entity, the first FM data corresponding to a current accounting period. In an embodiment, the first FM data specifies a fund, funds center, funded program, or a combination thereof, for the current accounting period for which a budget deficit or budget surplus prediction is sought.

In 304, input data generator 110 generates input data 112 for ML model 114 from the first FM data, wherein ML model 114 is trained to predict whether a budget deficit or a budget surplus will exist for the entity at the end of the current accounting period and wherein ML model 114 is trained based on training data generated from second FM data (e.g., associated with the entity), the second FM data corresponding to one or more previous accounting periods. In an embodiment, input data generator 110 generates input data 112 for ML model 114 from the first FM data by providing values associated with a set of account assignment variables of an availability control object (or budget address) for each fund, funds center, funded program, or combination thereof specified by the first FM data and for which a budget deficit or budget surplus predication is sought. In further accordance with this example, the set of account assignment variables may include or consist of the following: fund, budget period, funds center, commitment item, functional area, grant, and funded program.

In 306, input data generator 110 provides input data 112 as input to ML model 114, which processes input data 112 to produce the prediction of whether the budget deficit or the budget surplus will exist for the entity at the end of the current accounting period.

In 308, UI 118 obtains prediction 116 as an output from ML model 114, wherein prediction 116 indicates whether the budget deficit or the budget surplus will exist for the entity at the end of the current accounting period. UI 118 may present prediction 116 to a user. In an embodiment, 308 further includes UI 118 obtaining as an output from ML model 114 a probability associated with prediction 116, which UI 118 may also present to the user.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of removable storage unit 422 and interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or variable, but every embodiment can not necessarily include the particular feature, structure, or variable. Moreover, such phrases are not necessarily referring to the same embodiment. Further, when a particular feature, structure, or variable is described in connection with an embodiment, it would be within the knowledge of persons skilled in the relevant art(s) to incorporate such feature, structure, or variable into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for implementing a machine-learning-based budget utilization predictor, comprising:
receiving first funds management data associated with an entity, the first funds management data corresponding to a current accounting period;
generating input data for a machine learning (ML) model from the first funds management data, wherein the ML model is trained to predict whether a budget deficit or a budget surplus will exist for the entity at an end of the current accounting period, and wherein the ML model is trained based on training data generated from second funds management data associated with the entity, the second funds management data corresponding to one or more previous accounting periods;
providing the input data as input to the ML model; and
obtaining, as an output from the ML model, a prediction of whether the budget deficit or the budget surplus will exist for the entity at the end of the current accounting period;
wherein at least one of the receiving, generating, providing, and obtaining is performed by one or more computers.

2. The computer-implemented method of claim 1, further comprising:
training the ML model based on the training data generated from the second funds management data, the training the ML model comprising:
training a supervised ML classifier.

3. The computer-implemented method of claim 2, the training the supervised ML classifier comprising:
training a generalized linear model supervised ML classifier.

4. The computer-implemented method of claim 2, further comprising:
receiving the second funds management data from a funds management system; and
generating the training data from the second funds management data by extracting, from the second funds management data, a consumable amount, a consumed amount and an available amount for each unique combination of values associated with a plurality of account assignment variables that define an availability control object within the funds management system.

5. The computer-implemented method of claim 4, the generating the training data from the second funds management data further comprising:
filtering the second funds management data by one or more of a financial management area, a prior accounting year, or a ledger type.

6. The computer-implemented method of claim 4, wherein the plurality of account assignment variables include one or more of:
a fund variable;
a budget period variable;
a funds center variable;
a commitment item variable;
a functional area variable;
a grant variable; or
a funded program variable.

7. The computer-implemented method of claim 4, the generating the training data from the second funds management data further comprising:
for each unique combination of values associated with the plurality of account assignment variables:
converting the available amount to a Boolean value.

8. The computer-implemented method of claim 4, the generating the training data from the second funds management data further comprising:
performing principal component analysis to determine the plurality of account assignment variables.

9. The computer-implemented method of claim 1, further comprising:
obtaining, as an additional output from the ML model, a probability associated with the prediction of whether the budget deficit or the budget surplus will exist for the entity at the end of the current accounting period.

10. A system, comprising:
a memory; and
at least one processor coupled to the memory and configured to:
receive first funds management data associated with an entity, the first funds management data corresponding to a current accounting period,
generate input data for a machine learning (ML) model from the first funds management data, wherein the ML model is trained to predict whether a budget deficit or a budget surplus will exist for the entity at an end of the current accounting period, and wherein the ML model is trained based on training data generated from second funds management data associated with the entity, the second funds management data corresponding to one or more previous accounting periods;
provide the input data as input to the ML model; and
obtain, as an output from the ML model, a prediction of whether the budget deficit or the budget surplus will exist for the entity at the end of the current accounting period.

11. The system of claim 10, wherein the ML model comprises a supervised ML classifier.

12. The system of claim 11, wherein the supervised ML classifier comprises a generalized linear model supervised ML classifier.

13. The system of claim 10, the at least one processor further configured to;
receive the second funds management data from a funds management system; and
generate the training data from the second funds management data by extracting from the second funds management data a consumable amount, a consumed amount and an available amount for each unique combination of values associated with a plurality of account assignment variables that define an availability control object within the funds management system.

14. The system of claim 13, wherein to generate the training data from the second funds management data, the at least one processor is configured to:
filter the second funds management data by one or more of a financial management area, a prior accounting period, or a ledger type.

15. The system of claim 13, wherein the plurality of account assignment variables include one or more of:
a fund variable;
a budget period variable;
a funds center variable;
a commitment item variable;
a functional area variable;
a grant variable; or
a funded program variable.

16. The system of claim 13, wherein to generate the training data from the second funds management data, the at least one processor is configured to:
for each unique combination of values associated with the plurality of account assignment variables:
convert the available amount to a Boolean value.

17. The system of claim 13, wherein to generate the training data from the second funds management data, the at least one processor is configured to:
perform principal component analysis to determine the plurality of account assignment variables.

18. The system of claim 10, the at least one processor further configured to:
obtain, as an additional output from the ML model, a probability associated with the prediction of whether the budget deficit or the budget surplus will exist for the entity at the end of the current accounting period.

19. A non-transitory computer-readable device having instructions stored thereon that, when executed by at least one computing device, cause the at least one computing device to perform operations comprising:
receiving first funds management data associated with an entity, the first funds management data corresponding to one or more previous accounting periods;
generating training data from the first funds management data;
training a machine learning (ML) model based on the training data to predict whether a budget deficit or a budget surplus will exist for the entity at an end of a current accounting period;
receiving second funds management data associated with the entity, the second funds management data corresponding to the current accounting period;
generating input data for the ML model from the second funds management data;
providing the input data as input to the ML model; and
obtaining, as an output from the ML model, a prediction of whether the budget deficit or the budget surplus will exist for the entity at the end of the current accounting period.

20. The non-transitory computer-readable device of claim 19, the receiving the first funds management data comprising receiving the first funds management data from a funds management system, and the generating the training data from the first funds management data comprising:
extracting from the first funds management data a consumable amount, a consumed amount and an available amount for each unique combination of values associated with a plurality of account assignment variables that define an availability control object within the funds management system.
